(19) United States
(12) Patent Application Publication
(10) Pub. No.: US 2023/0046471 A1
(43) Pub. Date: Feb. 16, 2023

(54) MACHINE LEARNING ENHANCED CLASSIFIER

(71) Applicant: BigID Inc, New York, NY (US)

(72) Inventors: Yehoshua ENUKA, Gimzo (IL); David Charles Elie MOYAL, Tel Aviv-Yafo (IL); Eyal SACHAROV, Herzliya (IL)

(21) Appl. No.: 17/403,149

(22) Filed: Aug. 16, 2021

(51) Int. Cl. G06F 16/2455

(52) U.S. Cl. CPC G06F 16/24558

(57) ABSTRACT

The presently disclosed subject matter includes a computerized method and system that provide the ability to train and execute a unique machine learning (ML) model specifically configured to enhance classifier (e.g., RegEx) output by identifying and removing false positive results from the classifiers output. Classifier output, comprising a collection of data-subsets (e.g., columns in a relational database) of one or more structured or semi-structured data sources (e.g., tables of a relational database), are transformed to be represented by a plurality of numerical vectors. The numerical vectors are used during a training phase (as well as the execution phase) for training a machine learning model to enhance the classifier output and reduce false positives.

### FIELD OF THE PRESENTLY DISCLOSED SUBJECT MATTER

The presently disclosed subject matter relates to computerized systems and methods of database management.

### BACKGROUND

Organizations of all sorts use ever growing databases for storing and analyzing data. These organizations face different challenges in managing and curating the huge amounts of data across multiple data sources. These challenges also include those which are related to data discovery and data governance such as those prescribed by the General Data Protection Regulation (GDPR). As part of the management and usage of databases, string pattern matching with the help of classifiers are often used. Classifiers define specific rules for pattern searching, where the pattern comprises a desired sequence of characters and/or character types and provides a tool which facilitates searches and screening in databases. Classifiers can be implemented in various ways, each giving rise to a specific type of classifier. One example of classifiers are regular expressions (referred to herein in short as “RegExes”), which are an ordered sequence of characters, each character in the sequence representing a specific character or character type of a desired search pattern. A simple example of a regular expression in JAVA programming language is [abc] which defines a match to any string comprising the letter a or b or c, whereas the regular expression [a-d1-7] matches any letter between a and d and figures from 1 to 7, but not d1.

Another example of classifiers are code-based classifiers. One example of code-based classifiers implementation includes software snippets defining the rules for pattern searching. Another example of code-based classifiers implementation includes machine-learning based classifiers, where a machine learning model is trained for identifying desired patterns. A further example of a classifier is a heuristic classifier.

General Description

While classifiers provide a valuable tool when using databases, classifiers are deficient in different ways. For example, on the one hand a classifier which is too strict would miss a lot of valid results and thus provide many false negatives, while on the other hand a classifier which is too permissive would provide many false positives. Therefore, classifiers demand time consuming work for fine-tuning the classifiers to obtain the desired accuracy levels of the screening output.

The presently disclosed subject matter includes a computerized method and system directed for coping with the challenges related to classifiers in a scalable manner. The disclosed method and system provide the ability to train and execute a unique machine learning (ML) model specifically configured to enhance the classifier output by identifying and removing false positive results from the classifiers output.

As described below in more detail, classifier output comprising a collection of data-subsets (e.g., columns in a relational database) of one or more structured or semi-structured data sources (e.g., tables of a relational database), including both data-subsets which have been identified to have passed the pattern matching screening of the classifier (referred to herein below as “matching data-subsets”) and data-subsets which have been identified to have failed the pattern matching screening of the classifier (referred to herein below as “non-matching data-subsets”) are transformed to be represented by a plurality of numerical vectors. The numerical vectors are used during a training phase (as well as the execution phase), for training a machine learning model to enhance the classifier output and reduce false positives. Each numerical vector represents certain numerical characteristics of the data-values from which it is constructed.

According to some examples, the data-values in each data-subset are divided into subgroups and each subgroup is represented by a respective char_position vector. Division of values in a data-subset into subgroups may include dividing the values in a data-subset to a first subgroup of values comprising all matching data-values (i.e., values which have been identified to have passed the screening of the classifier), and a second subgroup of non-matching values (i.e., values which have been identified to have failed the screening of the classifier). A first numerical vector is thus generated for all matching values in the data-subset and a second numerical vector is generated for all non-matching values in the data-subset.

One example of a numerical vector is a features vector. A features vector (referred to herein also as “char_position vector”) is a numerical vector which stores features which represent the aggregated character position frequencies in data-values in a respective data-subset. The features vectors provide an accurate and easily maintainable representation of the pattern of the data-values in each data-subset.

The numerical vectors (e.g., features vectors) representing matching and non-matching values are used as input to the machine learning model, which are trained using supervised machine learning methods, to correlate between the patterns of matching and non-matching values and the respective classifier. During execution, this correlation is implemented by a trained machine learning model for removing false positives from the classifier output, thereby significantly improving the precision of the final output.

According to further examples, the precision of the final output is further improved by adding to the machine learning input one or more additional numerical vectors generated for each data-subset (e.g., columns) e.g., a features vector generated based on its name (referred to herein also as “name-features-vector”).

Enhancement of the accuracy of the classifier output enables to use more permissive classifiers, which require significantly less implementation effort. Using more permissive classifiers also facilitates the usage of computer programs for automatically generating classifiers which do not require human intervention (or at least considerably reduces the need for human intervention). It may also remove the need for a support term (a secondary classifier that helps to further enhance the classifier output, e.g., matching 16-digit numbers located in a column whose name is a string similar to “Credit Card”).

According to one aspect of the presently disclosed subject matter there is provided a computerized method of pattern (string) matching in data-subsets of one or more structured (e.g., relational databases) or semi-structured data sources, each data-subset comprising data-values; the method comprising using a processing circuitry for:

obtaining data indicative of matching data-subsets determined based on classifier data output; wherein the classifier data output is a product of applying on one or more data-subsets (from the one or more structured or semi-structured data sources) a classifier (e.g., regular expression) dedicated for identifying data-values that match a certain pattern (sequence of characters);

for each matching data-subset:

generating at least two respective numerical vectors (e.g., features vectors), comprising:

dividing the data-subset into a first subgroup comprising the matching data-values and a second subgroup comprising the non-matching data-values;

generating a first numerical vector (e.g., first features vector) from the data-values in the first subgroup and a second numerical vector (e.g., second features vector) from the data-values in the second subgroup;

executing a ML model, wherein the at least two numerical vectors are used as input to the ML model, wherein the ML model is configured for processing the at least two numerical vectors and identifying one or more data-subsets from the matching data-subsets, which represent false positive matching data-subsets, thereby enhancing the classifier output.

In addition to the above features, the method according to this aspect of the presently disclosed subject matter can optionally comprise one or more of features (i) to (xxi) below, in any technically possibly combination or permutation:

I. The computerized method further comprising applying the classifier on the one or more data-subsets to thereby obtain the classifier data output;

II. wherein the classifier is a regular expression (RegEx);

III. wherein the classifier is a machine learning based classifier;

IV. wherein the first numerical vector is a first features vector and the second numerical vector is a second features vector; wherein the first features vector comprises a first collection of features, each feature being indicative of an aggregated frequency of a respective n-gram-position pair in the first subgroup of data-values, and the second features vector comprises a second collection of features, each feature being indicative of an aggregated frequency of a respective n-gram-position pair in the second subgroup.

V. The computerized method further comprises classifying the data-subset as either matching or non-matching based on the relative portion of matching and non-matching data-values;

VI. wherein n-gram-position pairs in the first collection and the second collection includes unigrams-position pairs and/or bigram-position pairs.

VII. wherein the generation of the first features vector and the second features vector comprises:
dividing each data-value in the first subgroup and the second subgroup into n-grams;
assigning each n-grams with a respective value indicating its position within the respective data-value string, giving rise to a respective n-grams-position pair; and
for each one of the first subgroup and second subgroup, aggregating frequency of occurrence of each n-grams position pair in a respective vector, giving rise to a first features vector and second features vector.

VIII. The computerized method further comprising calculating a hash value for each feature (n-gram-position pair and their respective frequencies) in the first features vector and second features vector.

IX. The computerized method further comprising applying a hashing trick on the first features vector and the second features vector.

X. The computerized method further comprising applying a term frequency-inverse document frequency (TF-IDF) on the first features vector and the second features vector, thereby obtaining a respective TF-IDF score for each feature in the first features vector and the second features vector.

XI. The computerized method further comprising:
generating for each data-subset, one or more additional numerical vectors using respective data related to the data-subset and/or data-source.

XII. The computerized method, wherein the one or more additional numerical vectors are generated as word vectors representing the respective data.

XIII. The computerized method further comprising:
generating two additional features vectors, including a first name-features-vector and a second name-features-vector, wherein the first name-features-vector comprises a collection of features, each feature being indicative of an aggregated frequency of a respective n-gram-position pair in a name of the data-subset and the second name-features-vector comprising a collection of features, each feature being indicative of an aggregated frequency of a respective n-gram-position pair in a processed version of the name of the data-subset.

XIV. wherein the data-subsets are columns in a relational database.

XV. The computerized method further comprises implementing ML training, comprising:
applying the classifier on a plurality of data-subsets to thereby classify each data-value in each data-subset as matching or non-matching the classifier;
generating a sample dataset comprising multiple matching data-subsets and multiple non-matching data-subsets, wherein classification of a data-subset as matching or non-matching is according to a relative portion of matching and non-matching data-values in each respective data-subset;
for each data-subset in the sample dataset:
dividing the data-subset into a first subgroup comprising the matching data-values and a second subgroup comprising the non-matching data-values;
generating a first numerical vector (e.g., first features vector) from the data-values in the first subgroup and a second numerical vector (e.g., features vector) from the data-values in the second subgroup;
receiving user input indicative of whether the classification of each data-subset in the sample dataset to matching or non-matching, is true or false, thereby obtaining an annotated sample dataset;
using the first and second numerical vectors (e.g., features vectors) of each one of the data-subsets in the sample dataset as a training set for training the machine learning model for identifying false detections made by the classifier.

XVI. wherein the first numerical vector is a first features vector and the second numerical vector is a second features vector; wherein the first features vector comprises a first collection of features, each feature being indicative of an aggregated frequency of a respective n-gram-position pair in the first subgroup of data-values, and the second features vector comprises a second collection of features, each feature being indicative of an aggregated frequency of a respective n-gram-position pair in the second subgroup;

XVII. wherein the implementing of the training phase further comprises: calculating for each feature a respective hash value.

XVIII. wherein n-gram-position pairs in the first collection and the second collection generated during the training phase includes unigrams-position pairs and/or bigram-position pairs.

XIX. wherein the implementing of the training phase further comprises applying a hashing trick on the first features vector and the second features vector.

XX. wherein the implementing of the training phase further comprises generating for each data-subset in the sample dataset at least one additional numerical vector.

XXI. wherein the implementing of the training phase further comprises generating for each data-subset in the sample dataset at least two additional features vectors comprising a first name-features-vectors and a second name-features-vector, wherein the first name-features-vector comprises a collection of features, each feature being indicative of an aggregated frequency of a respective n-gram-position pair in a name of the data-subset and the second name-features-vector comprises a collection of features, each feature being indicative of an aggregated frequency of a respective n-gram-position pair in a processed version of the name of the data-subset.

According to another aspect of the presently disclosed subject matter there is provided a computerized system of pattern matching in data-subsets of one or more structured or semi-structured data sources, each data-subset comprising data-values; the system comprises a processing circuitry configured to:

obtain data indicative of matching data-subsets determined based on classifier data output; wherein the classifier data output is a product of applying on one or more data-subsets (from the one or more structured or semi-structured data sources) a classifier (e.g., regular expression) dedicated for identifying data-values that match a certain pattern;

for each matching data-subset:

generate at least two respective numerical vectors (e.g., features vectors), comprising:

divide the data-subset into a first subgroup comprising the matching data-values and a second subgroup comprising the non-matching data-values;

generate a first numerical vector (e.g., features vector) from the data-values in the first subgroup and a second numerical vector (e.g., features vector) from the data-values in the second subgroup;

execute a ML model, wherein the at least two numerical vectors are used as input to the ML model, wherein the ML model is configured for processing the at least two numerical vectors and identifying one or more data-subsets from the matching data-subsets, which represent false positive matching data-subsets, thereby enhancing classifier output.

According to another aspect of the presently disclosed subject matter there is provided a non-transitory program storage device readable by a computer, tangibly embodying a program of instructions executable by the computer to perform a method of pattern (string) matching in data-subsets of one or more structured (e.g., relational databases) or semi-structured data sources, each data-subset comprising data-values, the method comprising:

obtaining data indicative of matching data-subsets determined based on classifier data output; wherein the classifier data output is a product of applying on one or more data-subsets (from the one or more structured or semi-structured data sources) a classifier (e.g., regular expression) dedicated for identifying data-values that match a certain pattern (sequence of characters);

for each matching data-subset:

generating at least two respective numerical vectors (e.g., features vectors), comprising:

dividing the data-subset into a first subgroup comprising the matching data-values and a second subgroup comprising the non-matching data-values;

generating a first numerical vector (e.g., features vector) from the data-values in the first subgroup and a second numerical vector (e.g., features vector) from the data-values in the second subgroup;

executing a ML model, wherein the at least two numerical vectors are used as input to the ML model, wherein the ML model is configured for processing the at least two numerical vectors and identifying one or more data-subsets from the matching data-subsets, which represent false positive matching data-subsets, thereby enhancing classifier output.

The system and non-transitory program storage device, disclosed in accordance with the presently disclosed subject matter, can optionally comprise one or more of features (i) to (xxi) listed above, mutatis mutandis, in any technically possibly combination or permutation.

According to a further aspect of the presently disclosed subject matter there is provided a computerized method of training a machine learning (ML) model dedicated for detecting false detections determined based on a classifier applied on data-subsets of one or more structured or semi-structured data sources, each data-subset comprising data-values; the method comprising using a processing circuitry for:

generating a sample dataset comprising multiple matching data-subsets and multiple non-matching data-subsets, wherein classification of a data-subset as matching or non-matching is according to a relative portion of matching and non-matching data-values in each respective data-subset; wherein data-values in each data-subset are classified as matching or non-matching by applying the classifier on the data-values;

for each data-subset in the sample dataset:

dividing the data-subset into a first subgroup comprising the matching data-values and a second subgroup comprising the non-matching data-values;

generating a first numerical vector (e.g., first features vector) from the data-values in the first subgroup and a second numerical vector (e.g., second features vector) from the data-values in the second subgroup;

receiving user input indicative of whether the classification of each data-subset in the sample dataset, to matching or non-matching, is true or false, thereby obtaining an annotated sample dataset;

using the first and second numerical vectors of each one of the data-subsets in the sample dataset as a training set for training the machine learning model for identifying false detections made by the classifier.

In addition to the above features, the method according to this aspect of the presently disclosed subject matter can optionally comprise one or more of features (i) to (ix) below, in any technically possibly combination or permutation:

I. wherein the classifier is a regular expression (RegEx);

II. wherein the first numerical vector is a first features vector and the second numerical vector is a second features vector; wherein the first features vector comprises a first collection of features, each feature being indicative of an aggregated frequency of a respective n-gram-position pair in the first subgroup of data-values, and the second features vector comprises a second collection of features, each feature being indicative of an aggregated frequency of a respective n-gram-position pair in the second subgroup.

III. wherein generating the first and second numerical vectors further comprises calculating for each feature a respective hash value.

IV. wherein n-gram-position pairs in the first collection and the second collection includes unigrams-position pairs and/or bigram-position pairs.

V. The computerized method further comprising:
generating for each data-subset, one or more additional numerical vectors using respective data related to the data-subset and/or data-source.

VI. The computerized method wherein the one or more additional numerical vectors include at least one word vector representing the respective data.

VII. The computerized method further comprising:
generating for each data-subset in the sample dataset, two additional name-features-vectors, wherein the first name-features-vector comprises a collection of features, each feature being indicative of an aggregated frequency of a respective n-gram-position pair in a name of the data-subset, and the second name-features-vector comprising a collection of features, each feature being indicative of an aggregated frequency of a respective n-gram-position pair in a processed version of the name of the data-subset.

VIII. The computerized method further comprising calculating a hash value for each n-gram-position pair and their respective frequencies in the first numerical vector and second numerical vector.

IX. The computerized further comprising applying a term frequency-inverse document frequency (TF-IDF) on the first numerical vector and the second numerical vector, thereby obtaining a respective TF-IDF score for each feature in the first numerical vector and the second numerical vector.

X. The computerized method, wherein the ML model is of any one of the following types: Stochastic Gradient Descent model; Decision Tree; Logistic Regression; and Random Forest Classifier.

According to another aspect of the presently disclosed subject matter there is provided a computerized system configured for training a machine learning (ML) model dedicated for detecting false-positive detections determined based on a classifier applied on data-subsets of one or more structured or semi-structured data sources, each data-subset comprising data-values; the system comprising a processing circuitry configured to:

generate a sample dataset comprising multiple matching data-subsets and multiple non-matching data-subsets, wherein classification of a data-subset as matching or non-matching is according to a relative portion of matching and non-matching data-values in each respective data-subset; wherein data-values in each data-subset are classified as matching or non-matching by applying the classifier on the data-values;

for each data-subset in the sample dataset:

divide the data-subset into a first subgroup comprising the matching data-values and a second subgroup comprising the non-matching data-values;

generate a first numerical vector (e.g., a first features vector) from the data-values in the first subgroup and a second numerical vector (e.g., a second features vector) from the data-values in the second subgroup;

receive user input indicative whether the classification of each data-subset in the sample dataset, to matching or non-matching, is true or false, thereby obtaining an annotated sample dataset;

use the first and second numerical vectors of each one of the data-subsets in the sample dataset as a training set for training the machine learning model for identifying false detections made by the classifier.

According to another aspect of the presently disclosed subject matter there is provided a non-transitory program storage device readable by a computer, tangibly embodying a program of instructions executable by the computer to perform a method of training a machine learning (ML) model dedicated for detecting false detections determined based on a classifier applied on data-subsets of one or more structured or semi-structured data sources, each data-subset comprising data-values; the method comprising using a processing circuitry for:

generating a sample dataset comprising multiple matching data-subsets and multiple non-matching data-subsets, wherein classification of a data-subset as matching or non-matching is according to a relative portion of matching and non-matching data-values in each respective data-subset; wherein data-values in each data-subset are classified as matching or non-matching by applying the classifier on the data-values;

for each data-subset in the sample dataset:

dividing the data-subset into a first subgroup comprising the matching data-values and a second subgroup comprising the non-matching data-values;

generating a first numerical vector from the data-values in the first subgroup and a second numerical vector from the data-values in the second subgroup; receiving user input indicative of whether the classification of each data-subset in the sample dataset to matching or non-matching is true or false, thereby obtaining an annotated sample dataset;

using the first and second numerical vectors of each one of the data-subsets in the sample dataset as a training set for training the machine learning model for identifying false detections made by the classifier.

The system and non-transitory program storage device, disclosed in accordance with the presently disclosed subject matter, can optionally comprise one or more of features (i) to (ix) listed above, mutatis mutandis, in any technically possibly combination or permutation.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is schematic illustration of a database system, in accordance with an example of the presently disclosed subject matter;

FIG. 2 is a block diagram illustrating a processing circuitry, in accordance with an example of the presently disclosed subject matter;

FIG. 3 is a flowchart of operations carried out during an ML pre-processing phase (31) and ML training phase (33), in accordance with an example of the presently disclosed subject matter;

FIG. 4 is a simplified example of an annotated sample dataset, in accordance with an example of the presently disclosed subject matter;

FIG. 5 is a flowchart illustrating operations carried out during generation of a features vector, in accordance with an example of the presently disclosed subject matter; and

FIG. 6 is a flowchart of operations carried out during the execution phase, in accordance with an example of the presently disclosed subject matter.

### DETAILED DESCRIPTION

In the drawings and descriptions set forth, identical reference numerals indicate those components that are common to different embodiments or configurations. Elements in the drawings are not necessarily drawn to scale.

Unless specifically stated otherwise, as apparent from the following discussions, it is appreciated that, throughout the specification, discussions utilizing terms such as “generating”, “obtaining”, “dividing”, “executing”, “classifying”, “assigning” or the like, include an action and/or processes of a computer that manipulate and/or transform data into other data, said data represented as physical quantities, e.g. such as electronic quantities, and/or said data representing the physical objects.

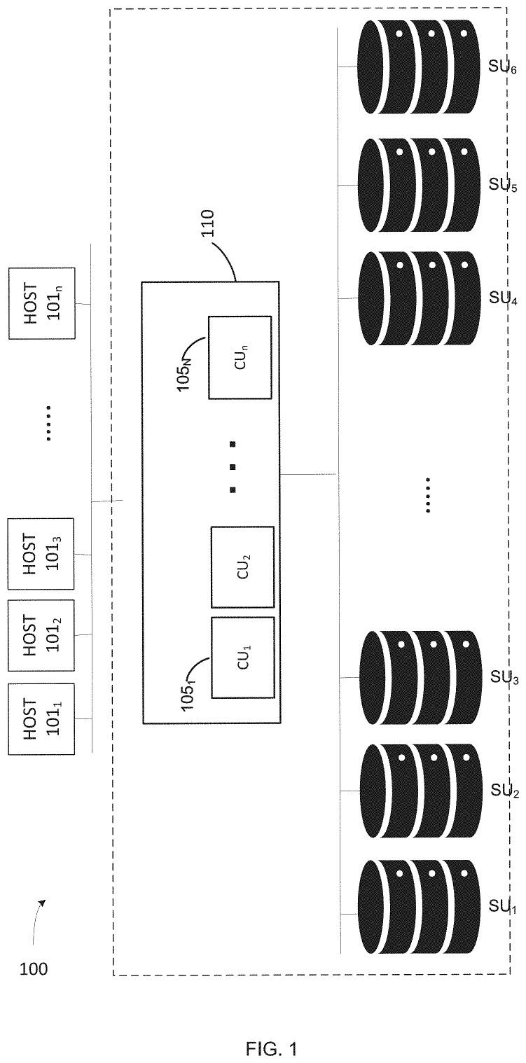

The terms “computer”, “computer device”, “computerized device” or the like, should be expansively construed to include any kind of hardware-based electronic device with a data processing circuitry (e.g., digital signal processor (DSP), a GPU, a TPU, a field programmable gate array (FPGA), an application specific integrated circuit (ASIC), microcontroller, microprocessor etc.). The processing circuitry can comprise, for example, one or more processors operatively connected to computer memory, loaded with executable instructions for executing operations as further described below. For example, control unit 105 described below with reference to FIG. 1 is a computerized device.

The operations in accordance with the teachings herein may be performed by a computer specially constructed for the desired purposes, or by a general-purpose computer specially configured for the desired purpose by a computer program stored in a computer readable storage medium.

As used herein, the phrase “for example,” “such as”, “for instance” and variants thereof, describe non-limiting embodiments of the presently disclosed subject matter. Reference in the specification to “one example”, “some examples”, “other examples”, or variants thereof, means that a particular feature, structure or characteristic described in connection with the embodiment(s) is included in at least one embodiment of the presently disclosed subject matter. Thus, the appearance of the phrase “one example”, “some examples”, “other examples” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately, or in any suitable sub-combination.

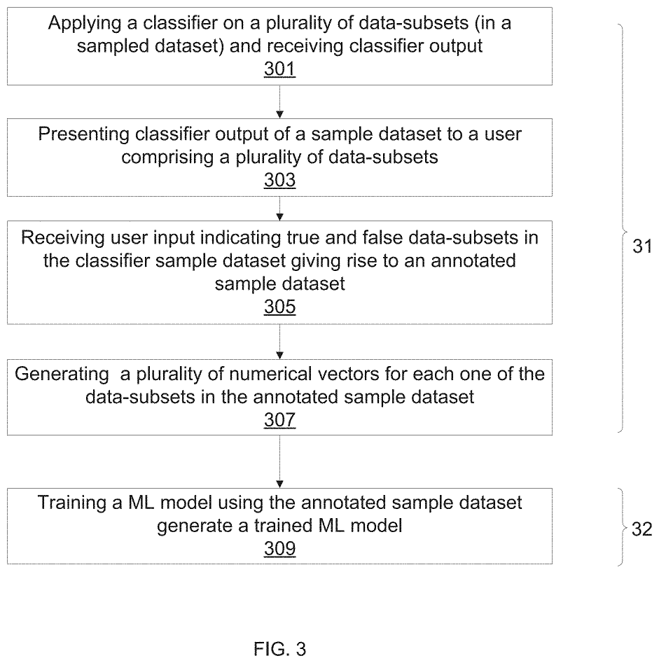

In embodiments of the presently disclosed subject matter, fewer, more and/or different stages than those shown in FIGS. 3, 5 and 6 may be executed. In embodiments of the presently disclosed subject matter, one or more stages illustrated in the figures may be executed in a different order, and/or one or more groups of stages may be executed simultaneously.

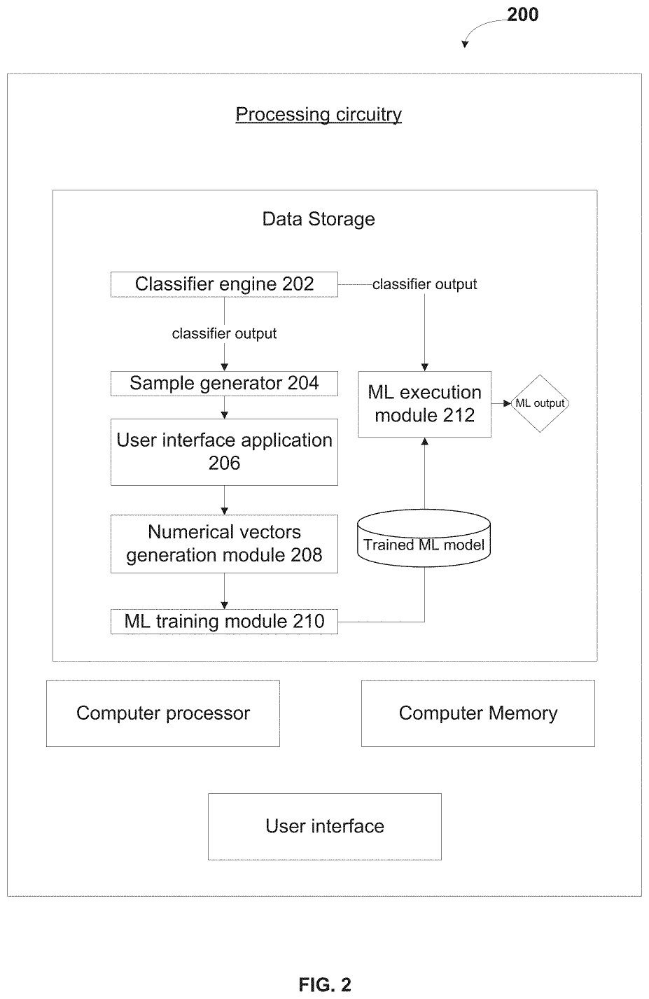

FIGS. 1 and 2 illustrate a general schematic of the system architecture in accordance with an embodiment of the presently disclosed subject matter. Elements in FIGS. 1 and 2 can be made up of any combination of software and hardware and/or firmware that performs the functions as defined and explained herein. Elements in FIGS. 1 and 2 may be centralized in one location or dispersed over more than one location. In other embodiments of the presently disclosed subject matter, the system may comprise fewer, more, and/or different elements than those shown in FIGS. 1 and 2. For example, FIG. 2 shows a single processing circuitry, while it should be clear to any person skilled in the art that a plurality of processing circuitries can be used instead. Likewise, the specific division of the functionality of the disclosed system to specific parts as described below, is provided by way of example, and other various alternatives are also construed within the scope of the presently disclosed subject matter. For example, FIG. 2 shows the ML execution module 212 together with the ML training module 210 in the same processing circuitry. As would be understood to any person skilled in the art, this is merely a non-limiting example. In other examples, the ML training module 210 and the ML execution module 212 can be distributed in different locations, where the former is executed by a first processing circuitry installed in a first computer located in one location (e.g., a remote database computer server 105) and the latter is executed by a second processing circuitry installed in a second computer located in another location (e.g., a client on premise host device 101) and where, the output of the first server is provided to the second server and used during execution. Likewise, other modules described with reference to FIG. 2 can be distributed, for example, classifier engine 202, sample generator 204 and ML training module 210 can be each executed on different computer devices which communicate over a communication link.

A structured data source is one whose elements are addressable for effective analysis. This includes, for example, relational databases organized in tables consisting of rows and columns (e.g., SQL databases). A semi-structured data source is one that is not stored in a relational database but that has some organizational properties that make it easier to analyze. This includes for example non-SQL databases, including but not limited to MongoDB. As used herein, and unless specifically indicated otherwise, the term “data-source” is used to include both a structured and a semi-structured data source, and the term “data-subset” is used to include a sub-component of a structured or semi-structured data source. Examples of data-subsets in structured data include columns and rows, and an example of a data-subset in a semi-structured data is a field retrieved from a plurality of documents in a MongoDB database, where the retrieved values collectively represent a data-subset. It is noted that while the following description predominantly refers to relational databases and their components, such as tables and columns, this is done by way of example only and should not be construed to limit the scope to relational databases alone. The presently disclosed subject matter can be likewise applied on other types of data resources, including semi-structured data resources (e.g., MongoDB).

As explained above, a classifier can be implemented in various ways, each giving rise to a specific type of classifier. In this regard it is noted that while the following description predominantly uses the term regular expression (RegEx), this is done by way of example only and should not be construed to limit the scope in any way. The presently disclosed subject matter contemplates and can be likewise applied with any other type of classifier. Bearing the above in mind, attention is drawn to FIG. 1, which is a schematic high-level block-diagram of a database system (DBS), according to some examples of the presently disclosed subject matter. DBS 100 includes a physical storage space comprising one or more physical storage units (SU₁₋ₙ), each physical storage unit comprising one or more storage devices configured to store data, e.g., in the form of relational tables. Storage devices may be any one of Hard Storage devices (HDD) or Solid-State Drives (SSD, comprising for example, a plurality of NAND elements), DRAM, non-volatile RAM, or any other computer storage device or combination thereof. Physical storage units (SU₁₋ₙ) can be consolidated in a single unit or can be otherwise distributed over one or more computer nodes connected by a computer network, where each node can be located at a different location, and in some cases be owned by a different owner.

DBS 100 can further comprise a database management layer 110 comprising one or more control units (CU 105₁₋ₙ) which are computerized devices, operatively connected to the physical storage space and to one or more hosts (101₁₋ₙ), and configured to control and execute various operations in the DBS. These operations include for example data retrieval requests, received from users (interacting with the DBS via hosts (101₁₋ₙ), or other applications interacting with the DBS. Other examples of operations, which may be performed by the control units are described in more detail below. A host includes any computer device which communicates with the database management layer 110 e.g., a PC computer, working station, a Smartphone, cloud host (where at least part of the processing is executed by remote computing services accessible via the cloud), or the like.

FIG. 2 is a block diagram illustrating a processing circuitry which can be implemented in a control unit 105 being part of database management layer 110, according to some examples of the presently disclosed subject matter. Processing circuitry 200 can comprise one or more computer processors operatively connected to a computer storage medium. The processing circuitry can be configured to execute functional modules in accordance with computer-readable instructions implemented on a non-transitory computer-readable storage medium. For simplicity, such functional modules are referred to hereinafter as components of the processing circuitry. A more detailed description of the operations of processing circuitry 200 is disclosed below with reference to the following figures.

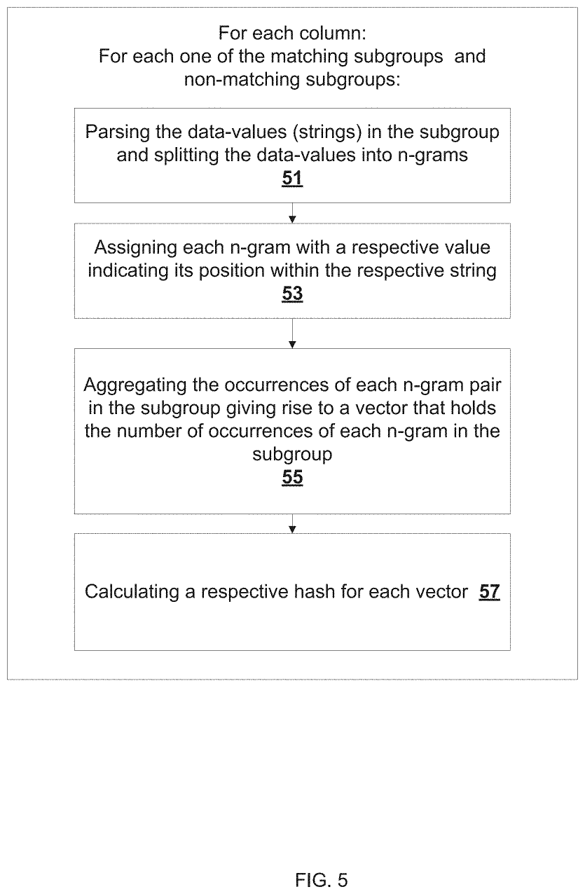

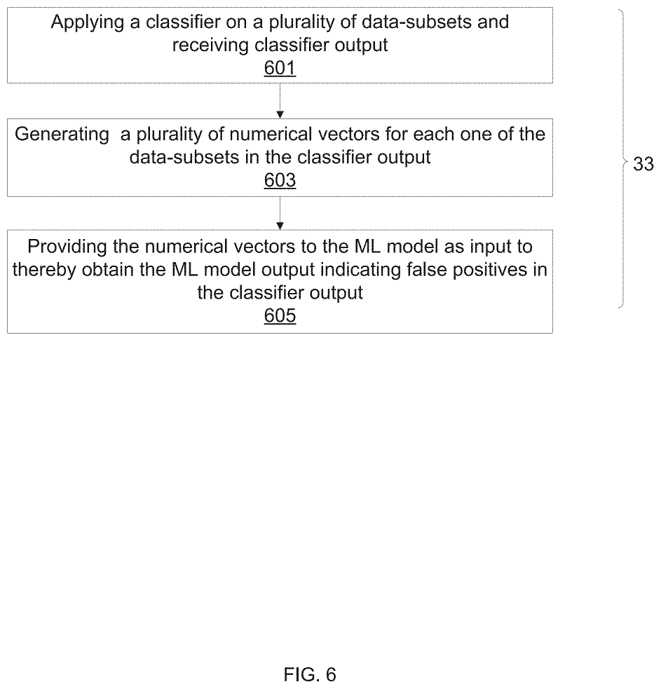

FIG. 3 is a flowchart showing operations carried out during a ML pre-processing phase (31), and a ML training phase (33), according to some examples of the presently disclosed subject matter. Operations in FIG. 3, (as well as FIGS. 5 and 6 below) are described with reference to corresponding functional elements which are illustrated in FIG. 2. However, this is done by way of example only and should not be construed to limit the scope of the presently disclosed subject matter to the specific components and/or design exemplified in FIG. 2.

The process disclosed with reference to FIG. 3 can be divided into three phases, ML pre-processing phase (31), ML training phase (33), and ML execution phase (35).

During the ML pre-processing phase, the training dataset is generated. During the training phase, the ML model is trained using the training dataset. During the ML execution phase, the trained ML model is applied on classifier output to identify and remove false positive results and thereby enhance the output.

More specifically, at block 301a classifier (e.g., RegEx) is applied on a collection of data-subsets (e.g., with the help of classifier engine 202). During the application, a plurality of data-subsets (e.g., columns) from one or more data sources (e.g., relational tables) are scanned with the classifier. During the scanning, data-values stored in each column are processed using the RegEx to determine whether the data-values match the RegEx. Metadata can be added with respect to each scanned data-value, indicating whether the string pattern of the data-value matches the RegEx requirements. The scanning output can include, for example, for each column, data indicating which of the data-values in the column are matching, and which of the data-values in the column are non-matching. Furthermore, in some examples, each one of the scanned columns is classified (and marked by appropriate metadata) as a “matching column” in case the portion of matching data-values in the column is greater than a certain predefined threshold (also referred to as “matching criterion”), and a “non-matching column” in case it does not. For example, a matching column can be defined as a column in which at least 10% (or 15% or 20% or 50%, etc.) of the data-values match the RegEx. Thus, the RegEx output data includes a collection of data-subsets (e.g., columns) where each data-subset is classified as matching or non-matching the respective RegEx, and the data-values in each data-subset are classified individually as matching or non-matching the respective RegEx. The RegEx output is stored in a transitory and/or non-transitory computer data-storage.

As the purpose is to create a training dataset for the machine learning model, in some examples only a sample of the data, which is sufficient for the training dataset, is processed. Thus, while tables in a relational database may include many columns (e.g., thousands and more) and columns may include many rows (e.g., ranging up to thousands, hundreds of thousands and more), a sample dataset which includes only a limited number of data-subsets, each comprising a limited number of data-values, can be used. According to some examples, a sample dataset is generated by randomly selecting several columns ‘n’ from a larger collection of columns (e.g., 10≥n≥5). In further examples, a certain number of data-values ‘m’ are randomly selected from each column in the sample to create a smaller sample dataset (e.g., 500≥m≥100). The columns are selected so they comprise both matching and non-matching columns. In one non-limiting example, an equal number of matching and non-matching columns are used. Considering that a minimum of n matching columns and n non-matching columns are required for the training dataset, in case the RegEx is applied before the selection of the sample dataset, at least n matching columns and at least n non-matching columns are randomly selected from the RegEx output to thereby obtain the required number of matching and non-matching columns for the sample dataset. Otherwise, if the sample dataset is generated before the application of the RegEx, it is ensured that the RegEx output comprises an adequate number of matching and non-matching columns. For example, assuming n≥5, the number of columns initially selected may include 50 (or 40, or 30, etc.) randomly selected columns, which are processed by the RegEx and 5 or more matching, and 5 or more non-matching columns are then randomly selected from the RegEx output to thereby obtain the required number of matching and non-matching columns. According to some examples, processing circuitry 200 includes a sample generator 204 configured to process the RegEx output and generate the sample dataset.

At block 303 the RegEx output of the sample dataset is presented to a user to enable the user to review and annotate the RegEx output. To this end, processing circuitry 200 can further comprise a user interface which comprises a user interface application 206 being operatively connected to user interface devices (including for example, display screen and input device such as keyboard, touchscreen, computer mouse, etc.). The user interface is configured to generate and display on a display device a graphical representation of the sample dataset. The displayed data includes the sampled data-values of each sampled column and, optionally, data indicating, with respect to each sampled data-value, whether it is a matching or a non-matching data-value according to the RegEx output.

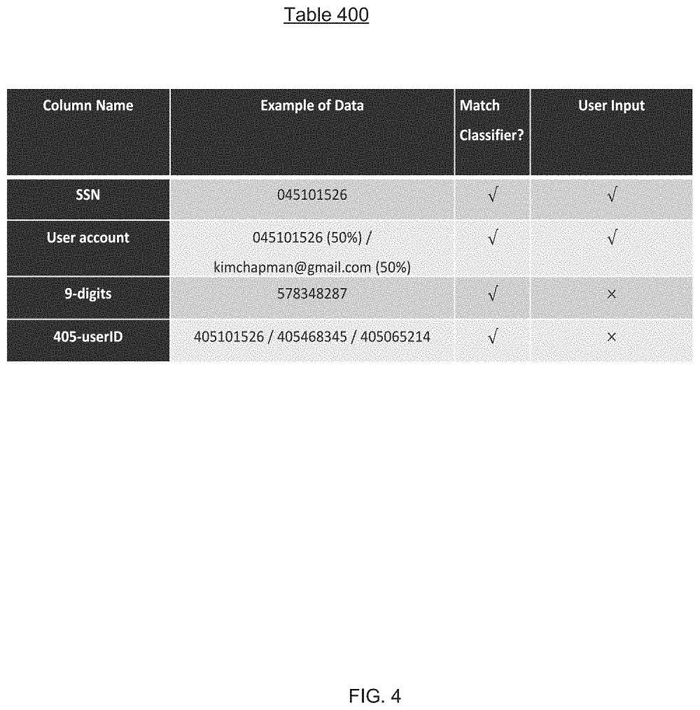

FIG. 4 shows a simplified and non-limiting example, where columns in a data source have been scanned using a RegEx dedicated for identifying American social security numbers (SSN). In the illustrated example, the RegEx output is displayed in the form of a table, where each row corresponds to a sampled column extracted from the RegEx output. The table (400) comprises, from left to right, a first column indicating the name of each sampled column, a second column showing examples of data-values found in each sampled column, and a third column showing data indicative as to whether the column has been determined as a matching or non-matching column. Assuming for example, the matching criterion is set to at least 30% matching data values, the output in the third column of table 400 indicates which column complies with this matching criterion. The user reviews the data-values in the sample dataset and provides data input indicating which of the data-values are matching and which are non-matching. For example, the fourth column on the far right of table 400 can be configured as an interactive user interface allowing the user to add annotations to the table, indicating whether the RegEx output is correct or incorrect. The user input provides information on false positive results in the RegEx output. Since the RegEx which is used is permissive, it is unlikely to get false negative results.

Reverting to FIG. 3, at block 305 the user input is received by the system, giving rise to a user annotated sample dataset. The annotated sample dataset is stored in a computer data-storage. In some examples where the user provides only input with respect to individual data-values in each column in the sample rather than matching and non-matching indication with respect to the entire column, the user input is used for calculating the percentage of the matching data-values out of the total data-values in each column and classifying the column as matching or non-matching according to the matching criterion (i.e., classifying the column as matching if percentage of matching data-values is greater than a predefined threshold).

At block 307 two or more numerical vectors are generated for each one of the columns in the sample dataset (e.g., by numerical vectors generation module 208). As mentioned above, a numerical vector represents certain numerical characteristics of the data-values from which it is constructed. An example of numerical vectors are features vectors (otherwise referred to as “char_position vectors”), which are vectors that store data indicative of the aggregated frequencies of different character-position in data-values in a respective data-subset (e.g., column). In the following descriptions of various aspects of the presently disclosed subject matter, features vectors are used as an example of numerical vectors, however this is done by way of example only for ease of understanding and should not be construed as limiting.

Recall that each data-value in the sample dataset has been classified by the RegEx engine as either matching or non-matching. Each column in the sample is divided into a first subgroup comprising matching data-values, and a second subgroup comprising non-matching data-values, where a first features vector is generated using all matching data-values in the column, and a second features vector is generated using all non-matching data-values in the column, giving rise to two features vectors generated for each column in the sample dataset.

FIG. 5 is a flowchart describing operations carried out during the generation of features vectors for a respective column, according to some examples of the presently disclosed subject matter. Notably, the same principles can be applied when generating features vectors in both the training phase and the execution phase. At block 51 the data-values (strings) in each one of the first subgroup and the second subgroup of each column in the dataset (e.g., sample dataset or tested dataset) are parsed and split into one or more types of n-grams. An n-gram is a substring of the data-value comprising one or more characters, where each type of n-gram comprises a specific number of characters. According to one example, data-values in the dataset are divided into unigram (individual characters), where, according to further examples, in addition or instead of the unigrams, the data-values in each one of the first and second subgroups of each column are split into bigrams (pairs of consecutive characters).

At block 53, each n-gram (e.g., of the type unigram and/or the type bigram) is assigned with a respective value indicating its position within the respective string, giving rise to a char-position pair or n-gram-position pair (e.g., unigram-position pair and bigram-position pair). At block 55 the occurrences of each n-gram-position pair in the first subgroup are aggregated, giving rise to a first vector (also referred to herein as a first “char position vector” of “first features vector”) that holds the number of occurrences of each n-gram-position pair. Likewise, the occurrences of each n-gram-position pair in the second subgroup are aggregated, giving rise to a second vector (also referred to herein as a second “char position vector” or “second features vector”) that holds the number of occurrences of each character-position pair. In case more than one type of n-gram is used (e.g., unigram and bigrams), the different type of n-grams-position pairs (e.g., unigrams-position pairs and bigrams-position pairs) are aggregated together in the same vector.

A simple example which demonstrates the principles of creating the features vector, is provided herein. Assuming a column ‘country’ consists of the values ‘USA’, ‘UK’ and ‘Uworld’ (the latter being negative to a ‘country’ RegEx), the aggregated vectors of unigrams and bigrams would be the following features (before applying the hashing trick):

First features vector (matching): [(‘U_0’, 2), (‘S_1’, 1), (‘A_2’, 1), (‘US_0, 1), (‘SA_1, 1), (‘K_1, 1), (‘UK_0’, 1)]; and

Second features vector (non-matching): [(‘U_0’, 1), (‘w_1’, 1), (‘o_2’, 1), (‘r_3’, 1), (‘I_4’, 1), (‘d_5’, 1), (‘Uw_0’, 1), (‘wo_1’, 1), (‘or_2’, 1), (‘r_3I’, 1), (‘Id_4’, 1)].

Each one of the vectors above are generated by aggregating features denoting one or more (in the current examples, two) types of n-gram-position pairs and their respective frequency. The annotation above indicates the frequency of occurrence (indicated by the digit at the right side of each feature) of each unigram-position pair and bigram-position pair (indicated by the n-gram-position pair at the left side of each feature) in the first vector generated for the matching subgroup of data-values and the frequency of occurrence of each unigram-position pair and bigram-position pair in the second vector generated for the non-matching subgroup of data-values.

For example, in the first vector (matching), the feature (‘U_0’, 2) indicates that the character (unigram) “U” appears in two data-values at the first position and the feature (‘SA_1’, 1) indicates that the bigram “SA” appears in one data-value at the second position. In the second vector (non-matching), the feature (‘w_1’, 1) indicates that the unigram “w” appears once in the second position and that the feature (‘Uw_0’, 1) indicates that the bigram “Uw” appears once in the first position.

At this point two features vectors are provided for each column, including the matching vector of the matching subgroup and the non-matching vector of the non-matching subgroup of each column. In some examples, one or more additional numerical vectors are generated. The additional numerical vectors can be generated based on various data related to the columns and/or the table. According to one example, a first additional numerical vector is a first name-features-vector which can be generated based on the raw column name, which is processed and transformed into a char-position vector (generated for example from its unigrams and bigrams-position pairs as described above). In some examples, a second numerical vector is added, where the name is first processed to clean the text and split into separated words (if it comprises more than one word), and a respective second name-features-vector and char-position vector is generated using the processing output. Thus, in some examples four numerical vectors (e.g., features vectors) are generated for each column of the sample dataset. According to another example, in addition or instead of the above name-features-vector, other additional features vectors can be generated using other data, including for example: the name of the table holding the data-subset (e.g., column), the names of one or more columns adjacent to the column, and any other metadata associated with the column and/or the table.

As explained above, the additional numerical vectors can be generated using the actual value (e.g., the actual column name as explained above) in which case a respective features vector and char-position vector are generated (e.g., name-features-vector). Alternatively, the additional numerical vectors can be generated using word vectors representing the respective data. For example, where the data is the name of the column, a word vector of the column name can be generated. As is well known in the art in natural language processing (NLP), a word vector is used for representing a word for text analysis, where the word vector encodes the meaning of the word, such that the words that are closer in the vector space are expected to be similar in meaning. Using word vectors can help for example to associate between different columns which have different names which have similar meanings. See for example word embedding in Wikipedia: (https://en.wikipedia.org/wiki/Word_embedding).

At block 57 a hash function is applied on each feature in each vector, thereby transforming the features vector to a vector of hashes. In some examples, to avoid the need to go over all the columns once to get all the char-position combinations that exist in all the data-values across all columns, the hashing trick is used. In short, a vectorizer that uses the hashing trick applies a hash function h to the elements in the vector (i.e., char-position), and then uses the hash values directly as feature indices. In other words, instead of assigning unique indices to each char-position pair, the hashing algorithm applies a hash function on the char-position string and uses the numerical output as the index of the specific char-position pair. For example, instead of assigning the unique index 0 to the ‘0_U’, char-position pair, the hashing trick algorithm applies a hash function to the string ‘0_U’ and uses the output of the hash function (e.g., 47) as the index of that specific char-position pair. To build a vector of a predefined length, the algorithm applies the modulo operation on the resulting hash values. Even if some of the hashed values collide, it usually does not significantly affect downstream computations.

After performing the hashing trick, two vectors are obtained (and possibly more if additional numerical vectors are generated). Note the shared hash that corresponds to the char-position pair “0_U” character that is found in both vectors:

First vector of hashes (matching): [(101, 2), (102, 1), (103, 1), (104, 1), (105, 1), (106, 1), (107, 1)]; and

Second vector of hashes (non-matching): [(101, 1), (108, 1), (109, 1), (110, 1), (111, 1), (112, 1), (113, 1), (114, 1), (115, 1), (116, 1), (117, 1)]

Notably, for simplicity, serial hashes are used in the example, however, in reality, the generated hashes are randomly scattered over a sufficiently large range of integers.

The operations described above with reference to FIGS. 3 and 5 can be executed multiple times, each time for a different RegEx, where each time a corresponding collection of features vectors are generated dedicated for training the ML model for enhancing the respective RegEx.

As mentioned above, some char-position pairs may appear in more than one of the features vectors. According to some examples, a term frequency-inverse document frequency (TF-IDF) transformation is applied on the features vectors. As is well known in the art, TF-IDF is a numerical statistic that is intended to reflect how important a word is to a document in a collection or corpus. The TF-IDF value increases proportionally to the number of times a word appears in the document and is offset by the number of documents in the corpus that contain the word, which helps to adjust for the fact that some words appear more frequently in general. In the current case TD-IDF is applied on the char position pairs to obtain information indicative of the char_position pairs which are most relevant for each features vectors. Meaning that if, for example, the char_position pair “a_0” appears in many values, in both the matching and not matching vectors, this indicates that it would have little contribution to the ML model for differentiating between matching and non-matching values. On the other hand, if “a_0” is found only in the matching values, this indicates that it would provide strong indication to the ML model for differentiating between matching and non-matching values.

In some examples, the output of the TF-IDF is a vector similar to the features vectors described above, where for each hash (generated from a char_position), a TF-IDF score is assigned in place of the number of occurrences.

Reverting to the training phase (32, block 309) in FIG. 3, during this phase, a machine learning model (referred to herein as “classifier enhancing ML model”) is trained using the annotated sample dataset as a training set. Note that the annotation indicates false positive output of the Regex. A non-limiting list of ML models which can be used, include a Stochastic Gradient Descent model, a Decision Tree, Logistic Regression, and a Random Forest Classifier. In some examples, where four features vectors are generated for each data-subset (e.g., column), the two name-features and the (TF-IDF-transformed) matching and non-matching features vectors are stacked together and fed into a Machine Learning Classifier model for training. In general, the trained machine learning model statistically correlates between the occurrence of n-grams (e.g., unigrams and bigrams) in matching and non-matching data-subsets on which a certain RegEx has been applied, thus providing a classifier that can further enhance the RegEx output. Data sub-sets which were falsely identified by the RegEx as matching, can be identified and removed. Training can be executed for example, by ML training module 210.

It is noted that the classifier enhancing ML model can be repeatedly trained using different sample datasets, thereby continuously improving the accuracy of the ML learning output. Since in each training iteration different data is being processed and user input is provided with respect to the processed data, the “knowledge base” of the ML model is continuously improved, thus enabling to improve its accuracy.

Proceeding to FIG. 6, this shows a flowchart of operations performed during the execution phase (33) of the ML model, according to some examples of the presently disclosed subject matter. Operations described with reference to FIG. 6 can be executed for example by ML execution module 212. Notably, in some examples ML execution module 212 can make use of other modules previously described with respect to the training phase, such as RegEx engine 202 and features generation module 208.

At block 601 a “tested dataset” of one or more data-subsets is processed using one or more RegEx. The tested dataset can be, for example, one or more tables of a relational database, each comprising a plurality of columns, or, in another example, a collection of columns specifically selected from one or more tables.

The RegEx are applied on the data-subsets in the tested dataset to thereby obtain a respective output of each RegEx. Given a certain RegEx, the output includes data indicative of each data-value in a data-subset, whether it is a matching or non-matching data-value. Based on the RegEx data output, data-subsets (e.g., columns) can be classified as matching data-subset or non-matching data-subset. As mentioned above, this is determined based on the relative portion of matching and non-matching data-values in the data-subset. Data-subsets which comprise a portion of the matching data-values which is greater than a certain threshold (e.g., >10% or >20% or >40% or >50%, etc.) are classified as matching data-subsets.

At block 603 features vectors are generated for each of the matching data-subsets, based on the matching and non-matching data-values in the matching data-subset. As mentioned above, according to some examples, one or more additional features vectors are generated based on the data-subset name. For example, a first name-feature can be generated based on the raw column name, which is processed and transformed into a char-position vector (generated from its unigrams and bigrams-position pairs). In some examples, a second name-feature is added, where the name is first processed to clean the text and split into separated words (if it comprises more than one word), and a respective char-position vector is generated using the processing output. Thus, in some examples four features vectors are generated for each column of the tested dataset. Notably, if more than one RegEx is applied on a given column, more than one collection of features vectors can be generated for the given column, each collection generated being based on the respective RegEx output. The process of generating the features vectors is explained above with respect to block 307 in FIG. 3 and FIG. 5. Notably, while during the training phase, features vectors are generated only for the data-subsets in the sample dataset, during the execution phase, features vectors are generated for all data-values in the tested dataset. As mentioned above, in some examples TF-IDF is applied on the collection of features vectors.

At block 605 a classifier enhancing ML model is executed using the collection of features vectors as input. As mentioned above, in case additional features vectors are generated for each data-subset (e.g., two additional name-features-vectors), the additional features vectors and the TF-IDF-transformed matching and non-matching features vectors are stacked together and fed into the classifier enhancing ML model. In some examples, the plurality of features vectors, generated for the same data-subset, are concatenated to a single vector which is used as ML input. In case a word vector is used for representing the additional data rather than features vectors, the corresponding word vector can be concatenated together with the other features vectors.

The ML learning model determines whether any of the matching data-subsets are false positives, i.e., are erroneously marked as matching by based on the RegEx output. If false-positives are identified, they can be marked and/or removed from the pool of matching data-subsets provided by the RegEx. For each specific RegEx, a respective classifier enhancing ML model is used for processing and enhancing the output of the specific RegEx.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable non-transitory memory tangibly embodying a program of instructions executable by the machine for executing the method of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A non-transitory program storage device readable by a computer, tangibly embodying a program of instructions executable by the computer to perform a method of identifying matching data-subsets from a plurality of data-subsets of one or more structured or semi-structured data sources, each data-subset comprising data-values; the method comprising:
before machine learning (ML) model execution:
obtaining data indicative of one or more matching data-subsets, each matching data-subset includes matching data-values determined by applying on the data-subset a classifier dedicated for identifying data-values that match a certain pattern; and
for each matching data-subset of the one or more matching data-subsets
generating at least two respective features vectors, comprising:
dividing the matching data-subset into a first subgroup comprising matching data-values identified as matching by the classifier and a second subgroup comprising non-matching data-values identified as non-matching by the classifier; and
generating a first features vector from the data-values in the first subgroup and a second features vector from the data-values in the second subgroup; wherein each feature in the first features vector is indicative of an aggregated frequency of a respective n-gram-position pair in the first subgroup, and each feature in the second features vector is indicative of an aggregated frequency of a respective n-gram-position pair in the second subgroup; wherein each n-gram-position pair indicates the position of a respective n-gram in a data value in the first subgroup or the second subgroup;
during ML model execution:
providing the at least two respective features vectors, of the one or more matching data-subsets, as input to the ML model; and
using the ML model for processing the at least two respective features vectors and for determining, based on both the first features vector generated from the matching data-values and the second features vector generated from the non-matching data-values, if exist at least one data-subset from the one or more matching data-subsets, which represents a false positive matching data-subset, thereby enhancing the classifier output.

2. (canceled)

3. The non-transitory program storage device of claim 1, wherein the n-gram-position pairs include unigrams-position pairs and/or bigram-position pairs.

4. The non-transitory program storage device of claim 1, wherein the generation of the first features vector and the second features vector comprises:
dividing each data-value in the first subgroup and the second subgroup into n-grams;
assigning each n-grams with a respective value indicating its position within a respective data-value string, giving rise to a respective n-grams-position pair; and
for each one of the first subgroup and second subgroup, aggregating frequency of occurrence of each n-grams position pair in a respective vector, giving rise to a first features vector and second features vector.

5. The non-transitory program storage device of claim 1, wherein the method further comprising calculating a hash value for each feature in the first features vector and second features vector.

6. The non-transitory program storage device of claim 1, wherein the method further comprising generating, for each matching data-subset, one or more additional features vectors using respective data related to the data-subset and/or data-source comprising the data-subset, wherein the one or more additional features vectors are also used as input to the ML model.

7. The non-transitory program storage device of claim 6, wherein the one or more additional features vectors include at least one word vector representing the respective data.

8. The non-transitory program storage device of claim 1, wherein the method further comprising:
generating two additional name-features-vectors to be used as input to the ML model; wherein a first name-features-vector comprises a collection of features, each feature being indicative of a respective n-gram in a name of the data-subset and a second name-features-vector comprises a collection of features, each feature is a respective n-gram in a processed version of the name of the data-subset.

9. The non-transitory program storage device of claim 1, wherein the method further comprising applying the classifier on the one or more data-subsets, thereby obtaining the classifier data output.

10. The non-transitory program storage device of claim 1, wherein the method further comprising implementing a ML training phase, comprising:
applying the classifier on a plurality of data-subsets to thereby classify each data-value in each data-subset as matching or non-matching the classifier;
generating a sample dataset comprising multiple matching data-subsets and multiple non-matching data-subsets, wherein classification of a data-subset as matching or non-matching is according to a relative portion of matching and non-matching data-values in each respective data-subset;
for each data-subset in the sample dataset:
dividing the data-subset into a first subgroup comprising matching data-values, and a second subgroup comprising non-matching data-values;
generating a first features vector from the data-values in the first subgroup, and a second features vector from the data-values in the second subgroup;
receiving user input indicative of whether classification of each data-subset in the sample dataset to matching or non-matching, is true or false, thereby obtaining an annotated sample dataset;
using the first features vector and the second features vectors of each one of the data-subsets in the sample dataset as a training set for training the ML model for identifying false detections made by the classifier.

11. The non-transitory program storage device of claim 10, wherein the first features vector comprises a first collection of features, each feature being indicative of an aggregated frequency of a respective n-gram-position pair in the first subgroup, and the second features vector comprises a second collection of features, each feature being indicative of an aggregated frequency of a respective n-gram-position pair in the second subgroup; wherein each n-gram-position pair indicates the position of a respective n-gram in a data value in the first subgroup or the second subgroup.

12. The non-transitory program storage device of claim 11, wherein generating the first features vector and the second features vectors further comprises calculating, for each feature, a respective hash value.

13. The non-transitory program storage device of claim 11, wherein n-gram-position pairs in the first collection and the second collection includes unigrams-position pairs and/or bigram-position pairs.

14. The non-transitory program storage device of claim 1, wherein the classifier is a regular expression (RegEx).

15. The non-transitory program storage device of claim 10, wherein the method further comprising:
generating for each data-subset in the sample dataset, one or more additional features vectors using respective data related to the data-subset and/or data-source, wherein the one or more additional features vectors are also used as input to the ML model.

16. The non-transitory program storage device of claim 11, wherein the method further comprising:
generating for each data-subset in the sample dataset, two additional name-features-vector to be used as input to the ML model; wherein a first name-features-vector comprises a collection of features, each feature is a respective n-gram in a name of the data-subset and a second name-features-vector comprises a collection of features, each feature is a respective n-gram in a processed version of the name of the data-subset.

17. A computerized system of identifying matching data-subsets from a plurality of data-subsets of one or more structured or semi-structured data sources, each data-subset comprising data-values; the system comprises a processing circuitry configured to:
before machine learning (ML) model execution:
obtain data indicative of one or more matching data-subsets, each data-subset includes matching data-values and is determined by applying on the data-subset a classifier dedicated for identifying data-values that match a certain pattern; and
for each matching data-subset of the one or more data-subsets
generate at least two respective features vectors, comprising:
divide the matching data-subset into a first subgroup comprising matching data-values identified as matching by the classifier and a second subgroup comprising non-matching data-values identified as non-matching by the classifier; and
generate at least two features vectors including a first features vector from the data-values in the first subgroup and a second features vector from the data-values in the second subgroup; wherein the first features vector comprises a first collection of features, each feature being indicative of an aggregated frequency of a respective n-gram-position pair in the first subgroup, and the second features vector comprises a second collection of features, each feature being indicative of an aggregated frequency of a respective n-gram-position pair in the second subgroup; wherein each n-gram-position pair indicates the position of a respective n-gram in a data value in the first subgroup or the second subgroup;
during ML model execution
provide the at least two features vectors of the one or more matching data-subsets, as input to the ML model; and
use the ML model for processing the at least two respective features vectors and for determining, based on both the a first features vector generated from the matching data-values and the second features vector generated from the non-matching data-values, if exists at least one data-subset from the one or more matching data-subsets, which represents a false positive matching data-subsets, thereby enhancing classifier output.

18. (canceled)

19. The computerized system of claim 17, wherein n-gram-position pairs in the first collection and the second collection include unigrams-position pairs and/or bigram-position pairs.

20. The computerized system of claim 17, wherein the processing circuitry is configured for generation of the first features vector and the second features vector, to:
divide each data-value in the first subgroup and the second subgroup into n-grams;
assign each n-grams with a respective value indicating its position within a respective data-value string, giving rise to a respective n-grams-position pair; and
for each one of the first subgroup and second subgroup, aggregate frequency of occurrence of each n-grams position pair in a respective vector, giving rise to a first features vector and second features vector.

21. The computerized system of claim 17, wherein the processing circuitry is further configured to calculate a hash value for each feature in the first features vector and second features vector.

22. The computerized system of claim 17, wherein the classifier is a regular expression (RegEx).

23. The computerized system of claim 17, wherein the processing circuitry is further configured to generate one or more additional features vectors using respective data related to the data-subset and/or data-source, wherein the one or more additional features vectors are also used as input to the ML model.

24. The computerized system of claim 17, wherein the processing circuitry is further configured to:
generate two additional name-features-vectors to be used as input to the ML model, wherein a first name-features-vector comprises a collection of features, each feature is indicative of a respective n-gram in a name of the data-subset and a second name-features-vector comprises a collection of features, each feature is indicative of a respective n-gram in a processed version of the name of the data-subset.

25. The computerized system of claim 17, wherein the processing circuitry is further configured to apply the classifier on the one or more data-subsets to thereby obtain the classifier data output.

26. A non-transitory program storage device readable by a computer, tangibly embodying a program of instructions executable by the computer to perform a method of training a machine learning (ML) model dedicated for detecting false detections in classifier output applied on data-subsets of one or more structured or semi-structured data sources, each data-subset comprising data-values; the method comprising using a processing circuitry for
generating a sample dataset comprising multiple matching data-subsets and multiple non-matching data-subsets, wherein classification of a data-subset as matching or non-matching is according to a relative portion of matching and non-matching data-values in each respective data-subset; wherein data-values in each data-subset are classified as matching or non-matching by applying the classifier on the data-values;
for each data-subset in the sample dataset:
generating at least two respective features vectors, comprising:
dividing the data-subset into a first subgroup comprising the matching data-values, identified as matching by the classifier, and a second subgroup comprising the non-matching data-values identified as non-matching by the classifier;
generating a first features vector from the data-values in the first subgroup and a second features vector from the data-values in the second subgroup; wherein the first features vector comprises a first collection of features, each feature being indicative of an aggregated frequency of a respective n-gram-position pair in the first subgroup, and the second features vector comprises a second collection of features, each feature being indicative of an aggregated frequency of a respective n-gram-position pair in the second subgroup; wherein each n-gram-position pair indicates the position of a respective n-gram in a data value in the first subgroup or the second subgroup;
receiving user input indicative of whether classification of each data-subset in the sample dataset to matching or non-matching, is true or false, thereby obtaining an annotated sample dataset;
using both the first features vector, generated based on the matching data-values, and the second features vector, generated based on the non-matching data-values of each one of the data-subsets in the sample dataset as a training set for training the ML model for identifying false positive detections made based on the classifier.

27. (canceled)

28. The non-transitory program storage device of claim 26, wherein n-gram-position pairs in the first collection and the second collection includes unigrams-position pairs and/or bigram-position pairs.

29. The non-transitory program storage device of claim 26, wherein the method further comprising:
generating for each data-subset in the sample dataset, one or more additional features vectors using respective data related to the data-subset and/or data-source, wherein the one or more additional features vectors are also used as input to the ML model.

30. The non-transitory program storage device of claim 26, wherein the method further comprising:
generating for each data-subset in the sample dataset, two name-features-vectors that are used as input for the ML model, wherein a first name-features-vector comprises a collection of features, each feature being indicative of a respective n-gram in a name of the data-subset, and a second name-features-vector comprises a collection of features, each feature being indicative of a respective n-gram in a processed version of the name of the data-subset.

31. A method of identifying matching data-subsets from a plurality of data-subsets of one or more structured or semi-structured data sources, each data-subset comprising data-values; the method comprising:
before machine learning (ML) model execution:
obtaining data indicative of one or more matching data-subsets, each matching data-subset includes matching data-values and is determined by applying on the data-subset a classifier dedicated for identifying data-values that match a certain pattern; and
for each matching data-subset of the one or more matching data-subsets
generating at least two respective features vectors, comprising:
dividing the matching data-subset into a first subgroup comprising matching data-values identified as matching by the classifier and a second subgroup comprising non-matching data-values identified as non-matching by the classifier; and
generating a first features vector from the data-values in the first subgroup and a second features vector from the data-values in the second subgroup; wherein each feature in the first features vector is indicative of an aggregated frequency of a respective n-gram-position pair in the first subgroup, and each feature in the second features vector is indicative of an aggregated frequency of a respective n-gram-position pair in the second subgroup; wherein each n-gram-position pair indicates the position of a respective n-gram in a data value in the first subgroup or the second subgroup;
during ML model execution:
providing the at least two respective features vectors, of the one or more matching data-subsets, as input to the ML model; and
using the ML model for processing the at least two respective features vectors and for determining, based on both the first features vector generated from the matching data-values and the second features vector generated from the non-matching data-values, if exist at least one data-subset from the one or more matching data-subsets, which represents a false positive matching data-subset, thereby enhancing the classifier output.

32. The method of claim 31, further comprising:
generating two additional name-features-vectors to be used as input to the ML model; wherein a first name-features-vector comprises a collection of features, each feature being indicative of a respective n-gram in a name of the data-subset and a second name-features-vector comprises a collection of features, each feature being indicative of a respective n-gram in a processed version of the name of the data-subset.

33. The non-transitory program storage device of claim 1, wherein the data-subsets are columns, and the structures or semi structured data resource is a relational database.
